(19) United States
(12) Patent Application Publication
(10) Pub. No.: US 2012/0261447 A1
(43) Pub. Date: Oct. 18, 2012

(54) GOLF EQUIPMENT HOLDER FOR CART

(76) Inventor: TIMOTHY BRYANT, PALM DESERT, CA (US)

(21) Appl. No.: 13/085,556

(22) Filed: Apr. 13, 2011

(51) Int. Cl. B60R 9/06

(52) U.S. Cl. 224/274

(57) ABSTRACT

A golf equipment holder for attachment to a golf cart. The holder has a golf rack with an elongated top bracket having apertures disposed along its length and a plurality of small holes. The golf rack further includes an elongated bottom bracket having apertures disposed along its length. Down tubes are disposed between the top and bottom bracket apertures. The down tubes are configured to receive the shafts of golf clubs while the small holes are configured to receive golf tees. The down tubes include bumpers for protecting the golf clubs during transit and drain plugs for draining water. The golf equipment holder beneficially also includes a putter holder, a golf bag holder, and a golf shoe cleaner. The golf equipment holder pivot mounts on a golf cart to provide better access to the golf equipment.

### FIELD OF THE INVENTION

The presently disclosed subject matter is directed towards golf equipment holders. More particularly, the present invention is directed to golf equipment holders for attachment to golf carts.

### BACKGROUND OF THE INVENTION

Golf is a very popular game that is enjoyed by players of almost all ages. Golf is based on precision control, or attempted precision control, of a golf ball by a golf player using golf clubs to put the golf ball into a golf hole. Competing golf players make use of different clubs to hit golf balls from golf tees into golf holes along a golf course. The player with the lowest number of hits, called strokes, over the course of a hole, a game (usually 9 or 18 holes) or a match wins.

While different golf courses have different designs, a feature that adds to the complexity of the game, golf is basically a rule driven game that all players are suppose to follow. An internationally standardized “Rules of Golf” controls almost every aspect of the game, from how to keep score to the number of clubs a player is allowed (13 clubs plus a putter). The controlling aspect of the rules of golf is fairness; no player is entitled to an unfair advantage over another player. The player comes as he is, plays the course as it is, and plays the ball as it lies. Based on those basic principles golfers almost always use “regulation” golf balls, tees, and clubs for fairness while attempting to obtain “fair” advantages over other players based on playing skills and experiences.

As noted above golf is played by almost all ages. In fact, golf is played by many individuals with health problems and/or physical infirmities. To make golf accessible to more players many courses and organizations allow golf carts to carry golfers and their golf equipment over the golf course.

Golf carts are motorized vehicles that are usually powered by propane, gas, or electricity. Operated like a car, a golf cart carries two to four players and their playing equipment. Typically a golf cart includes one or more attachments that retain a golf bag that carries the golf equipment to the cart for transportation over the golf course.

While generally successful, golf carts are somewhat less then ideal carriers of golfing equipment. First, golf equipment is usually stored in golf bags, which tend to locate golf clubs more or less randomly within the bag. This makes it less than ideal when selecting which club to use on any given stroke. Sometimes a golf club might be missing, and the use of a golf bag makes it more difficult to determine which, if any, club is missing. Furthermore, using golf bags makes it somewhat difficult to obtain golf tees and other supplies while golfing.

Therefore, a technique for carrying golfing equipment in a cart such that the golf equipment is readily accessible and visible would be beneficial. Even more beneficial would be a golf equipment holder that attaches to a golf cart and holds the golf equipment so that it is readily accessible and visible.

### BRIEF SUMMARY OF THE INVENTION

The principles of the present invention provide for golf equipment holders that attach to golf carts and that hold golf equipment so that it is readily accessible and visible to golf players. A golf equipment holder according to those principles includes an attachment for connecting to a golf cart. The golf equipment further includes a golf rack having a) an elongated top bracket with apertures disposed along its length along with a plurality of small holes, and b) an elongated bottom bracket having apertures disposed along its length. Down tubes are disposed between the top and bottom bracket apertures. The down tubes are configured to receive the shafts of golf clubs while the small holes are configured to receive inserts for holding golf tees. The down tubes beneficially include bumpers for protecting the golf clubs during transit and drain plugs for draining water. Beneficially a bumper can be removed to allow a down tube to hold an umbrella or a ball retriever. The golf equipment holder beneficially also includes a putter holder, a golf bag holder, a golf ball holder, and a golf shoe cleaner. The golf equipment holder attachment beneficially includes a pivot mount to provide better access to the golf equipment.

### BRIEF DESCRIPTION OF THE DRAWINGS

The advantages and features of the present invention will become better understood with reference to the following detailed description and claims when taken in conjunction with the accompanying drawings, in which like elements are identified with like symbols, and in which:

FIG. 1 is a front view of a golf equipment holder that is in accord with the principles of the present invention and that is attached to a golf cart;

FIG. 2 is a perspective view of a punched top “L” bracket used in the golf equipment holder illustrated in FIG. 1;

FIG. 3 is a perspective view of a plug on the top end of a down tube used in the golf equipment holder illustrated in FIG. 1;

FIG. 4 is a perspective view of a drain plug on the bottom end of a down tube used in the golf equipment holder illustrated in FIG. 1,

FIG. 5A is a side view of the golf equipment holder illustrated in FIG. 1 illustrated in its fully upright position;

FIG. 5B is a side view of the golf equipment holder illustrated in FIG. 1 illustrated in fully tilted downward; and

FIG. 6 is a view of the golf equipment holder shown in FIG. 1 having a golf bag holder attachment and holding golf clubs.

### DETAILED DESCRIPTION OF THE INVENTION

The presently disclosed subject matter now will be described more fully hereinafter with reference to the accompanying drawings in which a particular embodiment is shown. However, it should be understood that this invention may take many different forms and thus should not be construed as being limited to the embodiment set forth herein. Note that in the figures like numbers refer to like elements throughout.

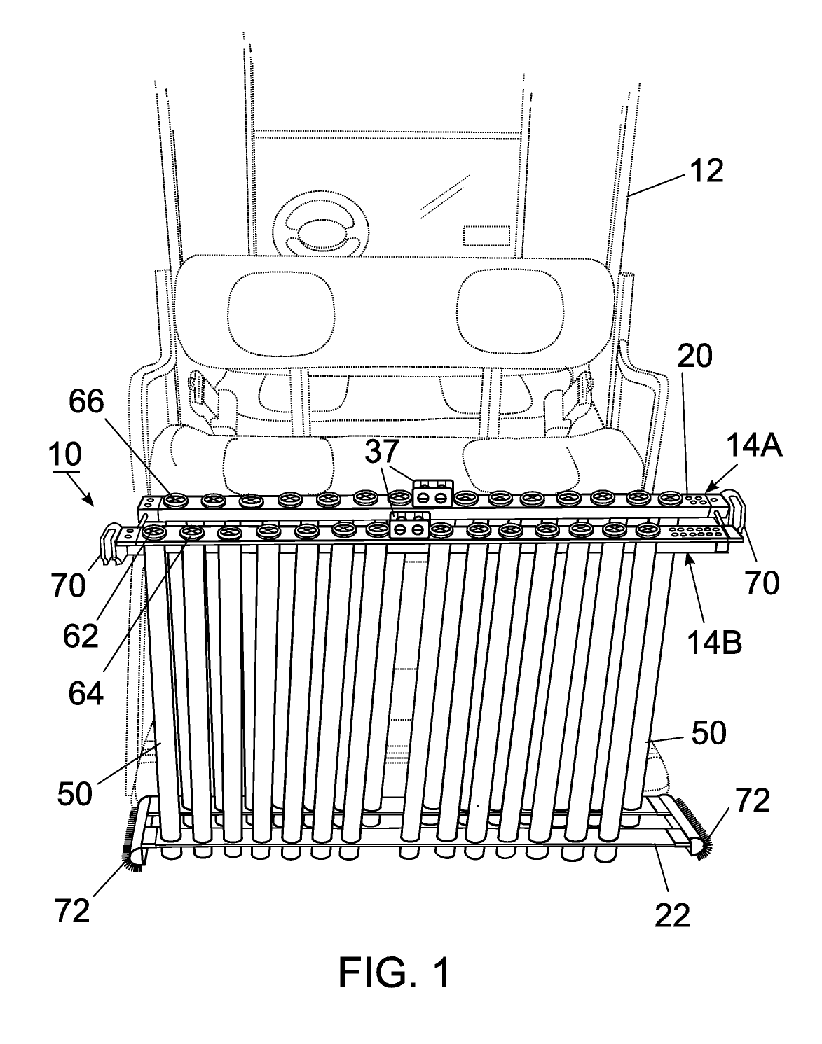

The present invention is described herein with reference to FIGS. 1 to 6. Specifically, the present invention is a golf equipment holder 10 that attaches to a golf cart 12 and that holds golf equipment so that it is readily accessible and visible to golf players.

FIG. 1 illustrates a golf equipment holder 10 that is attached to a golf cart 12. As shown the golf equipment holder 10 uses two slightly different golf racks, a back rack 14A and a front rack 14B. It should be understood that two golf racks 14 are not specifically required. A golf equipment holder 10 that is in accord with the present invention might have only one golf rack 14, or it might have more than two golf racks 14.

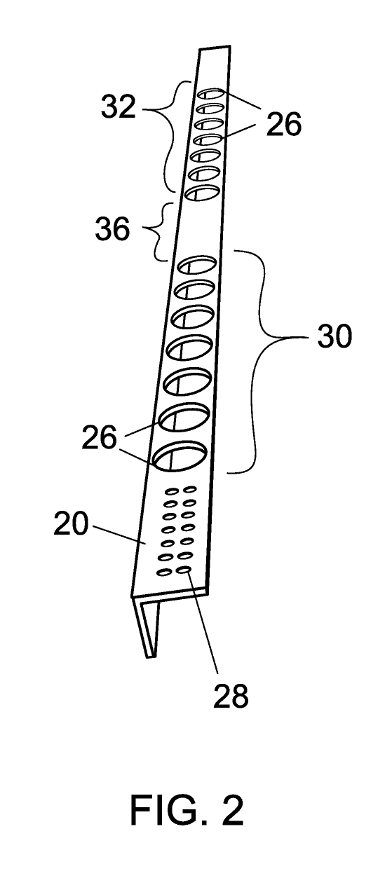

Still referring to FIG. 1, each of the golf racks 14A and 14B are comprised of an elongated top “L” bracket 20 and an elongated bottom “L” bracket 22. Turning now to FIG. 2, each of the top “L” brackets 20 includes 14 punched apertures 26 disposed along the length of the top “L” bracket 20 and a plurality of small holes 28 that are located on one side of the top “L” bracket 20. As shown in FIG. 1, the number of small holes 28 on each of the top “L” brackets 20 does not have to be the same. However, referring back to FIG. 2, for ease of fabrication, top “L” brackets 20 having the same number of small holes 28 will usually be preferable. Beneficially, the 14 apertures 26 are grouped into two sections, one section 30 having 7 apertures 26 and the other section 32 having 7 apertures 26. The two sections 30 and 32 are noticeably separated by a space 36. The purpose of grouping the apertures 26 as shown is explained subsequently. Beneficially the bottom “L” bracket 22 is almost the same as the top “L” bracket 20 except that the bottom “L” bracket 22 does not need a putter holder 40 or the small holes 28. For ease of assembly, punching (or drilling) of the holes and apertures, and low weight it is beneficial that the top “L” bracket 20 and the bottom “L” bracket 22 are made of aluminum or from an aluminum alloy.

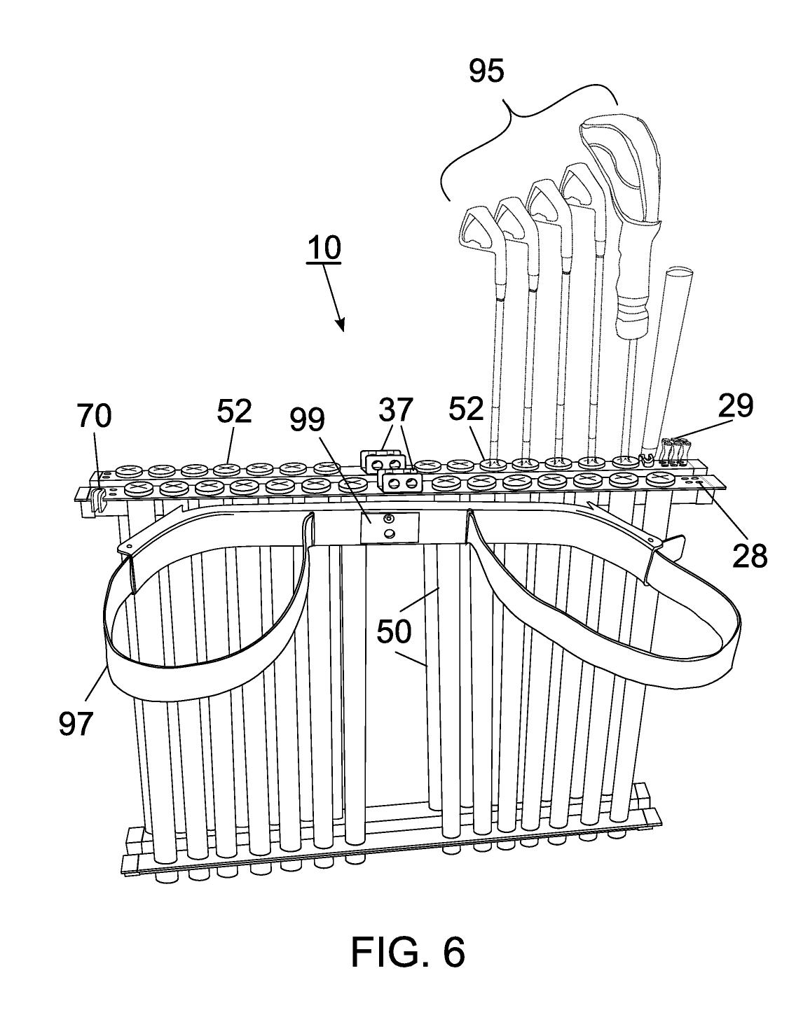

Turning back to FIG. 1, between the top “L” bracket 20 and the bottom “L” bracket 22 are twenty-eight (28) down tubes 50. Those down tubes 50 are used to hold and protect golf clubs (see FIG. 6), umbrella's, and ball retrievers when being transported. For cost, ease of assembly and fabrication, and low weight it beneficial that the down tubes 50 are comprised of plastic, aluminum, or an aluminum alloy.

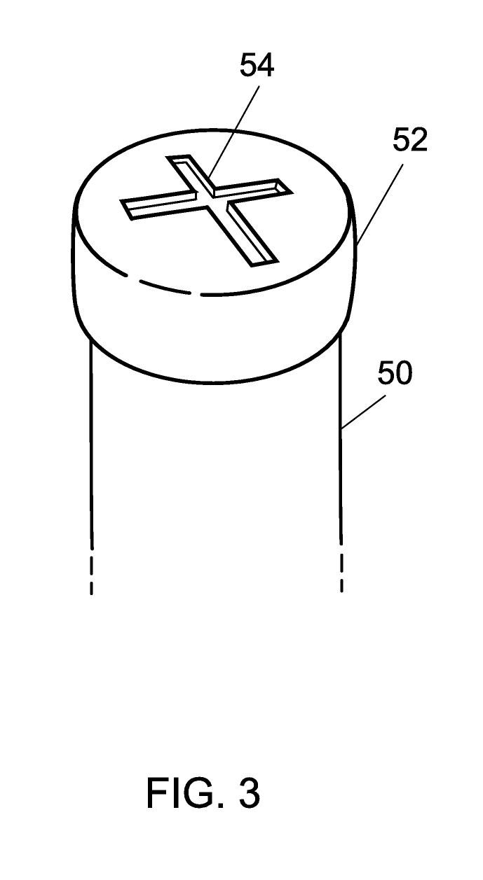

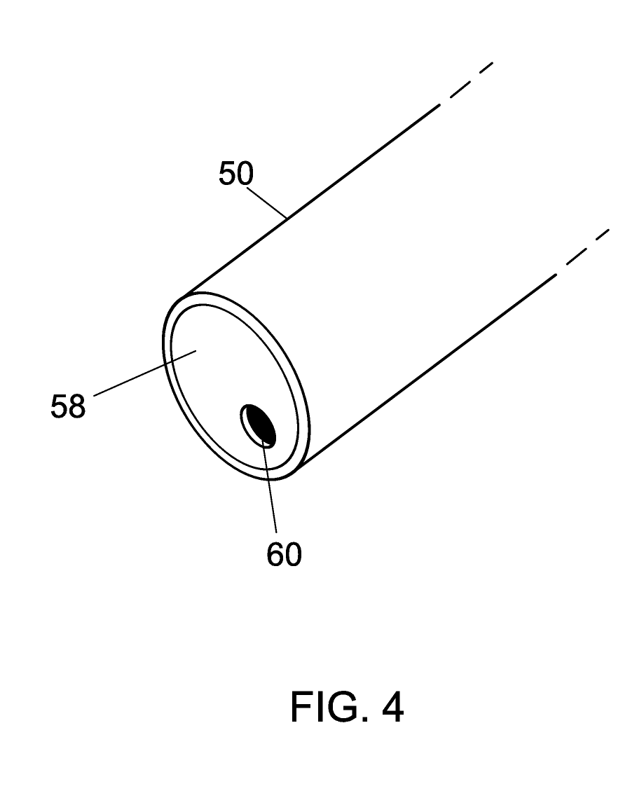

Referring now to FIG. 3, on the top of each down tube 50 is a bumper 52 having an “X” shaped opening 54. Referring now to FIG. 4, at the bottom of each down tube 50 is a plug 58 having a drain hole 60. To aid assembly and for best performance (see below) it is beneficial that the bumpers 52 are comprised of polyurethane or rubber. The plugs 58 are beneficially comprised of a hard plastic.

As previously noted the two golf racks 14A and 14B are slightly different. Referring now once again to FIG. 1, the major difference between the racks 14A and 14B is that the down tubes 50 of the two racks are slightly offset. That is, when looking straight onto the racks 14A and 14B from their front the first down tube 50 of the front rack 14B, shown as having a position 62, is to the left of the first down tube 50 of the back rack 14A, shown as position 66. Preferably, looking straight onto the two racks 14A and 14B the first down tube 50 of the back rack 14A is midway between the first and second down tubes 50 of the rack 14B, shown as positions 62 and 64.

Referring now back to FIG. 2, as noted above the “L” shaped brackets 20 (and 22) have a space 36 between sections 30 and 32. Those spaces 36, one on each of the tracks 14A and 14B, divide the golf equipment holder 10 such that there are 14 down tubes to the left of the spaces 36 and 14 down tubes to the right of the space 36. As the “Rules of Golf” mandate that no player can use more than 13 clubs (plus one putter) the golf equipment holder 10 visually separates one golfer's equipment from another. The extra down tube 50 on each side of the space allows a golfer to carry an umbrella or a ball retriever.

The small holes 28 shown in FIG. 2 are used to hold golf tees. As golf tees would tend to bounce out of the small holes if placed directly into the small holes 28, compression inserts 29 are inserted into the small holes 28 as shown in FIG. 6. Golf tees are then inserted into the compression inserts 29. The compression inserts are beneficially comprised of either rubber or polyurethane.

Referring now back to FIG. 1, each of the racks 14A and 14B includes at least one putter holder 70. Beneficially the putter holder 70 for the back rack 14A is on one side of the golf equipment holder 10 while the putter holder 70 for the front rack 14B is on the other side. Another useful feature of the golf equipment holder 10 is the golf shoe brushes 72 disposed between the bottom “L” shaped brackets 22. Those brushes enable golfers to clean the bottoms of their golf shoes. Additionally, a golf ball holder 37 can be attached to one or both top “L” brackets 20 (see FIG. 2), preferably in the space 36.

Referencing FIG. 6, in operation a player places his or her clubs 95 into the down tubes 50, preferably either to the left of the space 36 or to the right of that space. This is accomplished by turning the golf clubs upside down and inserting the shafts through the “X” shaped apertures 54 (labeled in FIG. 3, not labeled in FIG. 6 for clarity) of the bumpers 52. The bumpers 52, being comprised of non-scratching material such as polyurethane or rubber, prevent scratching and marring of the golf club 95 shafts as the golf cart 12 (see FIG. 1) is driven over the golf course. The “X” shaped apertures 54 unavoidably allow rain water into the down tubes 50. However, the drain 60 in the plug 58 (see FIG. 4) at the bottom of each down tube 50 drains that water out.

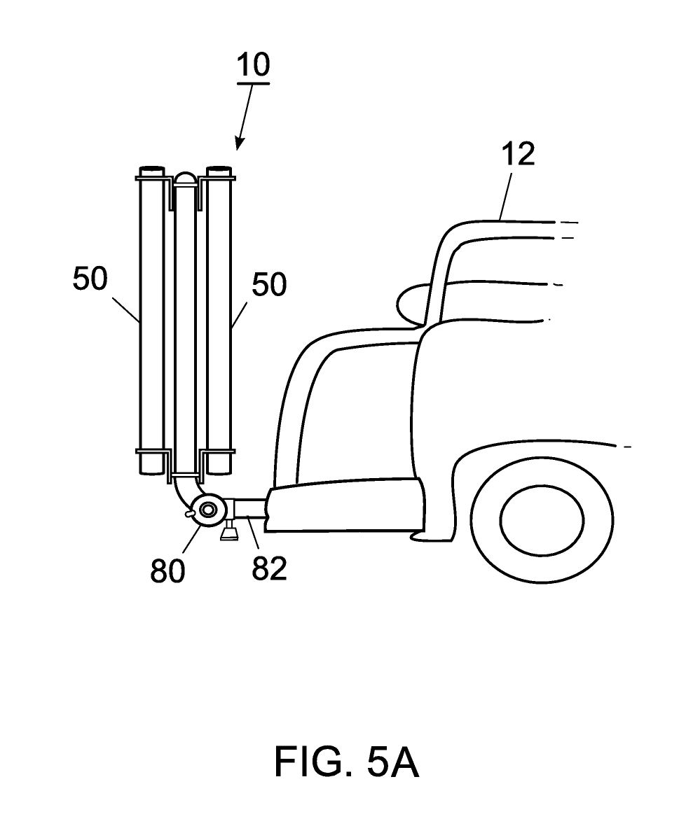

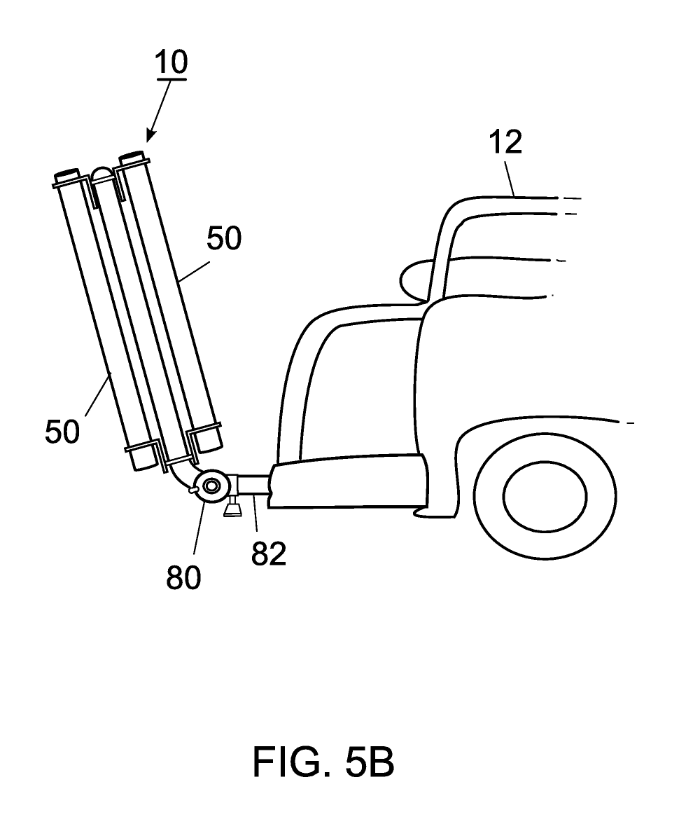

To assist players, particularly shorter players, the golf equipment holder 10 attaches to a golf cart in such a way that the golf equipment holder 10 can be tilted forward, beneficially at an angle of about 15 degrees. FIG. 5A shows the golf equipment holder 10 attached to a golf cart 12 via a foot operated pivotal mount 80 on a shaft 82 that connects to the golf cart 12. FIG. 5A shows the golf equipment holder 10 in a fully upright orientation, while FIG. 5B shows the golf equipment holder 10 tilted forward.

While FIGS. 5A and 5B illustrate a tilt mechanism for attaching the golf equipment holder 10 to a golf cart 12, other tilting mechanisms will also work. In particular, if the golf equipment holder 10 becomes excessively heavy the act of tilting the golf equipment holder 10 using the pivot mount of FIG. 5A and 5B may become too difficult for some users. Counter-balancing the pivot mount 80, limiting the range of tilt, or using a different tilt mechanism are envisioned. Additionally, some golf equipment holders in accord with the principles of the present invention may not include a tilt mechanism. In such cases the attachment of a golf equipment holder to a golf cart may be performed very differently.

The golf equipment holder 10 can beneficially be modified to include additional accessories. For example, FIG. 6 illustrates a golf bag holder 97 attached to the back of the golf equipment holder 10 on a top “L” bracket using a mounting bracket 99.

Again, it should be understood that the golf equipment holder 10 is simply an embodiment of the present invention. Therefore, it is to be understood that while the figures and the above description illustrate the present invention, they are exemplary only. They are not intended to be exhaustive or to limit the invention to the precise forms disclosed, and obviously many modifications and variations are possible in light of the above teaching. Others who are skilled in the applicable arts will recognize numerous modifications and adaptations of the illustrated embodiments that remain within the principles of the present invention. Therefore, the present invention is to be limited only by the appended claims.

What is claimed:

1. A golf equipment holder, comprising:
means to attach to a golf cart; and
a golf rack comprised of an elongated top bracket having a plurality of apertures disposed along its length along with a plurality of small holes; an elongated bottom bracket having a plurality of apertures disposed along its length; and a plurality of down tubes disposed between said top bracket apertures and said bottom bracket apertures;
wherein said plurality of down tubes are dimensioned and configured to receive shafts of golf clubs and said plurality of small holes are configured to receive golf tees.

2. A golf equipment holder according to claim 1, wherein said top bracket is “L” shaped.

3. A golf equipment holder according to claim 1, wherein said top bracket is made from aluminum.

4. A golf equipment holder according to claim 1, further including a second golf rack comprised of an elongated second top bracket having a plurality of second apertures disposed along its length and a plurality of second small holes; an elongated second bottom bracket having a second plurality of apertures disposed along its length; and a second plurality of down tubes disposed between said second top bracket apertures and said second bottom bracket apertures.

5. A golf equipment holder according to claim 4 wherein said plurality of apertures and said plurality of second apertures are offset.

6. A golf equipment holder according to claim 1, wherein said down tubes are comprised of plastic.

7. A golf equipment holder according to claim 1, wherein said down tubes are comprised of aluminum.

8. A golf equipment holder according to claim 1, further including a golf shoe brush attached to said elongated bottom bracket.

9. A golf equipment holder according to claim 1, further including a golf bag holder attached to said elongated top bracket.

10. A golf equipment holder according to claim 1, further including a golf putter holder attached to said elongated top bracket.

11. A golf equipment holder according to claim 1, further including at least one bumper inserted into the top of at least one down tube.

12. A golf equipment holder according to claim 11, wherein said at least one bumper includes an “X” shaped opening for receiving a golf shaft.

13. A golf equipment holder according to claim 11, wherein said at least one bumper is comprised of polyurethane.

14. A golf equipment holder according to claim 11, wherein said at least one bumper is comprised of rubber.

15. A golf equipment holder according to claim 1, further including at least one plug inserted into the bottom of at least one down tube, wherein said plug includes a drain hole.

16. A golf equipment holder according to claim 1, further including a plurality of compression insert inserted into said plurality of small holes.

17. A golf equipment holder according to claim 1, further including a golf ball holder attached to said elongated top bracket.

18. A golf equipment holder according to claim 1, wherein said means to attach to a golf cart includes a pivotal mount.

19. A golf equipment holder according to claim 18, wherein said pivotal mount selectively tilts said golf equipment holder forward.

20. A golf equipment holder according to claim 19, wherein said pivotal mount is foot operated.
